(19) United States
(12) Patent Application Publication
(10) Pub. No.: US 2015/0149130 A1
(43) Pub. Date: May 28, 2015

(54) POWER CONSUMPTION PREDICTION APPARATUS, METHOD, AND NON-TRANSITORY COMPUTER READABLE STORAGE MEDIUM THEREOF

(71) Applicant: Institute For Information Industry, Taipei (TW)

(72) Inventors: Yu-Sheng CHIU, Kaohsiung City (TW); Shiao-Li TSAO, Taipei City (TW); Yung-Chi CHEN, Taichung City (TW); Shih-Tsui KUO, Taipei City (TW)

(73) Assignee: Institute For Information Industry, Taipei (TW)

(21) Appl. No.: 14/194,239

(22) Filed: Feb. 28, 2014

(30) Foreign Application Priority Data
Nov. 22, 2013 (TW) 102142609

(51) Int. Cl. G06N 7/00

(52) U.S. Cl. CPC G06N 7/00
USPC 703/2

(57) ABSTRACT

A power consumption prediction apparatus, method, and non-transitory computer readable storage medium thereof are provided. The power consumption prediction apparatus receives a plurality of power consumption data of an appliance, wherein the power consumption data have a temporal sequence. Each power consumption datum includes a recorded status and a recorded time length, wherein each recorded status is one of a plurality operation statuses of the appliance. The power consumption prediction apparatus calculates an average operation time length of each operation status according to the recorded statuses and the recorded time lengths and calculates at least one transferring probability of each operation status according to the temporal sequence and the power consumption data. Each transferring probability is the probability of entering into a target status from a source status, wherein the source status is one of the operation statuses and the target status is one of the operation statuses.

### PRIORITY

This application claims priority to Taiwan Patent Application No. 102142609 filed on Nov. 22, 2013, which is hereby incorporated by reference in its entirety.

### FIELD

The present invention relates to a power consumption prediction apparatus, method, and non-transitory computer readable storage medium thereof; and more particularly, the present invention relates to a power consumption prediction apparatus, method, and non-transitory computer readable storage medium thereof which are based on using probability of an appliance.

### BACKGROUND

Electric power has already become the main energy source for the modern life. To manage the electric power, a number of technologies for predicting power consumption have been provided. However, these conventional power consumption prediction technologies are mainly used in the power supply system as a reference for power dispatch in the local power system or as a reference for the power generating capacity.

In fact, for end users, it is also necessary to predict the power consumption of small facilities (e.g., a single factory, a smart building, a smart home, etc.) in order to save power and reduce the electric charge. To predict the power consumption of end users, most of the conventional technologies need to collect power consumption data of a long period (e.g., one year) from the users, or take the data sensed by temperature sensors and humidity sensors as a reference for prediction. These conventional technologies usually adopt such techniques as the neural network and the genetic algorithm to predict the power consumption. However, these technologies require a long time period of training, and when they are used in relatively small facilities, the prediction result is not so precise as when being used in large facilities.

Accordingly, an urgent need exists in the art to provide a technology capable of establishing a power consumption model of an appliance rapidly to predict the future power consumption of the appliance.

### SUMMARY

To solve the problems with the prior art, the present invention includes a power consumption prediction apparatus, method, and non-transitory computer readable storage medium thereof.

The power consumption prediction apparatus provided in certain embodiments of the present invention comprises an interface and a processing unit, wherein the interface and the processing unit are electrically connected to each other. The interface receives a plurality of power consumption data of an appliance, wherein the appliance has a plurality of operation statuses and the power consumption data have a temporal sequence. Each of the power consumption data includes a recorded status and a recorded time length corresponding to the recorded status, and each of the recorded statuses is one of the operation statuses. The processing unit is configured to calculate an average operation time length of each of the operation statuses according to the recorded statuses and the recorded time lengths. The processing unit is also configured to calculate at least one transferring probability of each of the operation statuses according to the temporal sequence and the power consumption data. Each of the transferring probabilities is the probability of entering into a target status from a source status, the source status is one of the operation statuses, the target status is one of the operation statuses, and the source status is different from the target status.

The power consumption prediction method provided in certain embodiments of the present invention is executed by a computer. The power consumption prediction method comprises the following steps of: (a) receiving a plurality of power consumption data of an appliance, wherein the appliance has a plurality of operation statuses, the power consumption data have a temporal sequence, each of the power consumption data includes a recorded status and a recorded time length corresponding to the recorded status, and each of the recorded statuses is one of the operation statuses, (b) calculating an average operation time length of each of the operation statuses according to the recorded statuses and the recorded time lengths, and (c) calculating at least one transferring probability of each of the operation statuses according to the temporal sequence and the power consumption data. Each of the transferring probabilities is the probability of entering into a target status from a source status, the source status is one of the operation statuses, the target status is one of the operation statuses, and the source status is different from the target status.

The non-transitory computer readable storage medium provided in certain embodiments of the present invention includes a computer program stored therein. When the computer program is loaded into an electronic apparatus, the computer program executes a power consumption prediction method. The power consumption prediction method comprises the steps of: (a) receiving, by the electronic apparatus, a plurality of power consumption data of an appliance, wherein the appliance has a plurality of operation statuses, the power consumption data have a temporal sequence, each of the power consumption data includes a recorded status and a recorded time length corresponding to the recorded status, and each of the recorded statuses is one of the operation statuses, (b) calculating, by the electronic apparatus, an average operation time length of each of the operation statuses according to the recorded statuses and the recorded time lengths, and (c) calculating, by the electronic apparatus, at least one transferring probability of each of the operation statuses according to the temporal sequence and the power consumption data. Each of the transferring probabilities is the probability of entering into a target status from a source status, the source status is one of the operation statuses, the target status is one of the operation statuses, and the source status is different from the target status.

The present invention according to certain embodiments establishes a power consumption model of an appliance by using the power consumption data collected from the appliance. If other power consumption data are collected subsequently, the subsequently collected power consumption data will be used to update the power consumption model. Through continuous updating, the power consumption model can reliably reflect the average operation time lengths of the appliance under different operation statuses and the transferring probabilities between the different operation statuses. Once the power consumption model is established, the present invention can predict the subsequent power consumption of the appliance. Briefly speaking, the present invention firstly determines a current status (i.e., one of the operation statuses of the appliance) of the appliance at a current time point and also the passed time length elapsed after the appliance entered into the current status according to a power feature datum. Thereafter, the present invention calculates a remaining dwell time of the appliance in the current status, and then calculates a predicted power consumption of the appliance from the current time point to a target time point according to the remaining dwell time and the information of the power consumption model. Thereby, the present invention can establish the power consumption model of the appliance to predict the future power consumption of the appliance by simply using a small amount of power consumption data collected from the appliance and without using any additional environment data (e.g., temperature data, humidity data and etc.).

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view depicting a power consumption prediction apparatus of a first embodiment;

FIG. 1B is a schematic view depicting first power consumption data;

FIG. 1C is a schematic view depicting a power consumption model of an appliance;

FIG. 2A is a main flowchart diagram depicting a power consumption prediction method of a second embodiment; and

FIG. 2B is a detailed flowchart diagram of a step S23.

### DETAILED DESCRIPTION

In the following description, the power consumption prediction apparatus, method, and non-transitory computer readable storage medium thereof provided by the present invention will be explained with reference to example embodiments thereof. However, these example embodiments of the present invention are not intended to limit the present invention to any particular examples, embodiments, environment, applications or implementations described in these example embodiments. Therefore, description of these embodiments is only for purpose of illustration rather than to limit the present invention. It shall be appreciated that, in the following embodiments and the attached drawings, elements unrelated to the present invention are omitted from depiction.

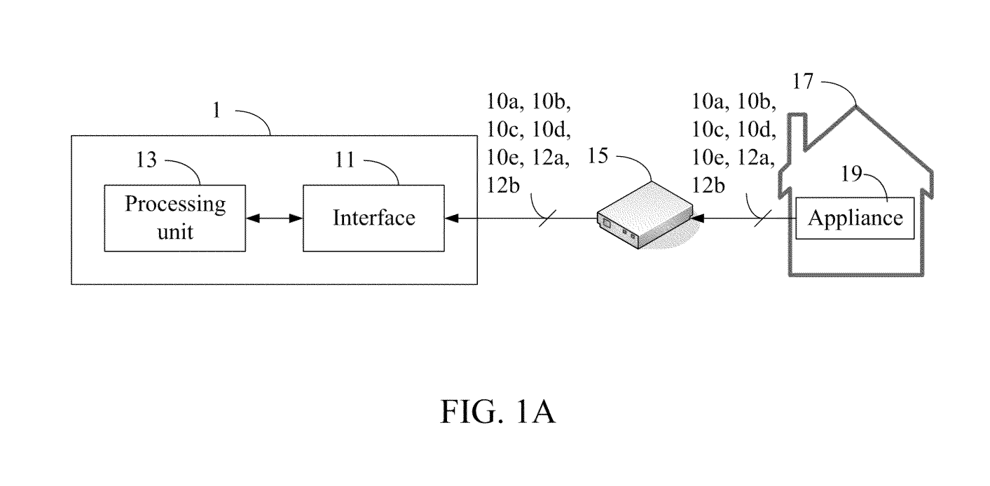

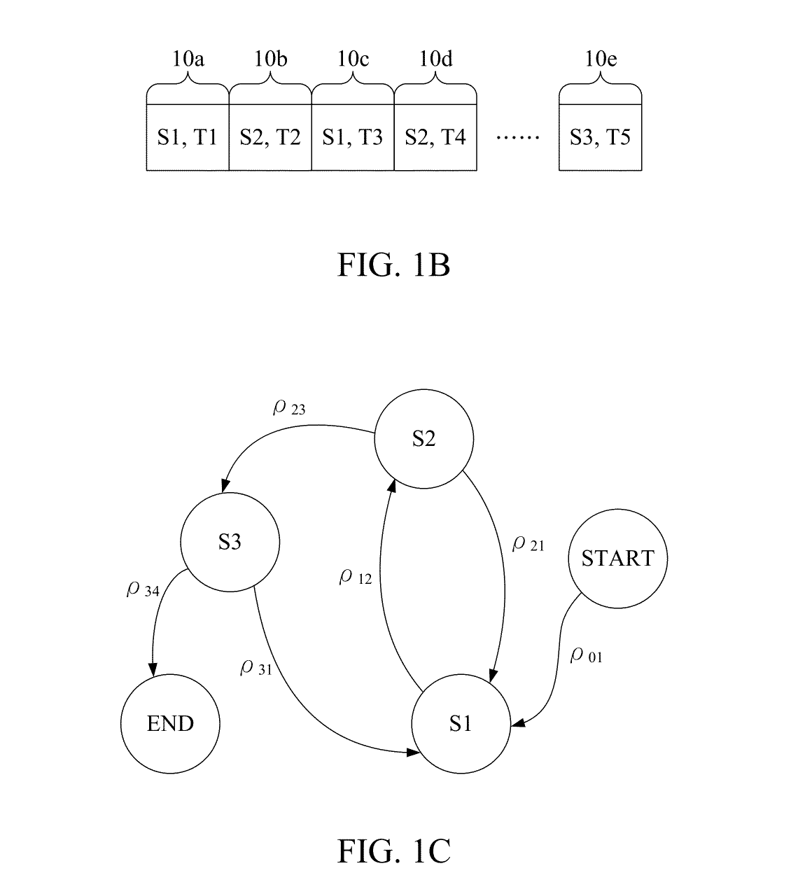

A first embodiment of the present invention is a power consumption prediction apparatus 1, a schematic view of which is depicted in FIG. 1A. The power consumption prediction apparatus 1 comprises an interface 11 and a processing unit 13 which are electrically connected to each other. The interface 11 may be any kind of interfaces capable of receiving and transmitting signals. The processing unit 13 may be any of various processors, central processing units (CPUs), microprocessors, or other computing devices well known to those of ordinary skill in the art.

In this embodiment, the interface 11 is electrically connected to a smart meter 15, and the smart meter 15 is connected to an appliance 19 in a building 17. It shall be appreciated that, in other implementations of the present invention, the smart meter 15 may be replaced by a non-invasive load monitoring apparatus. The appliance 19 in the building 17 has a plurality of operation statuses. For example, if the appliance 19 is an electric fan, the operation statuses thereof may comprise “HIGH”, “MODERATE”, “LOW”, “START” and “END”. It shall be appreciated that, as can be readily appreciated by those of ordinary skill in the art, different appliances have different statuses and also have different numbers of statuses. In this embodiment, the appliance 19 has five operation statuses S1, S2, S3, START and END. The interface 11 receives a plurality of first power consumption data 10a, 10b, 10c, 10d, . . . , 10e of the appliance 19 through the smart meter 15. Referring to FIG. 1B together, a schematic view of the first power consumption data 10a, 10b, 10c, 10d, . . . , 10e is depicted therein. The first power consumption data 10a, 10b, 10c, 10d . . . 10e have a first temporal sequence. According to the first temporal sequence, the first power consumption datum 10a is earlier than the first power consumption datum 10b, the first power consumption datum 10b is earlier than the first power consumption datum 10c, and so on. Each of the first power consumption data 10a, 10b, 10c, 10d, . . . , 10e includes a first recorded status and a first recorded time length corresponding to the first recorded status, and each of the first recorded statuses is one of the five operation statuses S1, S2, S3, START and END of the appliance 19. Briefly speaking, each of the first power consumption data 10a, 10b, 10c, 10d, . . . , 10e records a certain time length during which the appliance 19 operates under a certain operation status. In this embodiment, the first power consumption datum 10a includes a recorded status S1 and a first recorded time length T1, the first power consumption datum 10b includes a recorded status S2 and a first recorded time length T2, the first power consumption datum 10c includes the recorded status S1 and a first recorded time length T3, the first power consumption datum 10d includes the recorded status S2 and a first recorded time length T4, and the first power consumption datum 10e includes a recorded status S3 and a first recorded time length T5.

Next, the processing unit 13 establishes a power consumption model of the appliance 19 according to the first power consumption data 10a, 10b, 10c, 10d, . . . , 10e. It shall be appreciated that, the power consumption model includes an average operation time length of the appliance 19 under each of the operation statuses S1, S2, S3, START and END, and transferring probabilities of the appliance 19 transferring from one operation status to another operation status.

Specifically, the processing unit 13 calculates the average operation time length under each of the operation statuses S1, S2, S3, START and END according to the first recorded statuses and the first recorded time lengths included in the first power consumption data 10a, 10b, 10c, 10d, . . . , 10e. For example, the processing unit 13 calculates the average operation time length of each of the operation statuses by performing the following operations on each of the operation statuses S1, S2, S3, START and END: (a) selecting at least one from the first power consumption data 10a, 10b, 10c, 10d, . . . , 10e as at least one selected power consumption datum, wherein the first recorded status of each of the at least one selected power consumption datum is the operation status, and (b) averaging the at least one first recorded time length corresponding to the at least one selected power consumption datum as the average operation time length of the operation status. Taking the operation status S1 as an example, the processing unit 13 selects the first power consumption data 10a, 10c as the selected power consumption data, and then averages the first recorded time lengths (i.e., the first recorded time lengths T1, T3) included in the selected power consumption data (i.e., the first power consumption data 10a, 10c) as the average operation time length of the operation status S1. It shall be appreciated that, in other implementations of the present invention, the processing unit may also calculate the average operation time length of each of the operation statuses in other ways, e.g., by taking the median or the mode as the average operation time length.

Furthermore, the processing unit 13 calculates at least one transferring probability of each of the operation statuses S1, S2, S3, START and END according to the first power consumption data 10a, 10b, 10c, 10d, . . . , 10e and the temporal sequence thereof. Each of the transferring probabilities is the probability of entering into a target status from a source status, wherein the source status is one of the operation statuses S1, S2, S3, START and END, the target status is also one of the operation statuses S1, S2, S3, START and END, and the source status is different from the target status.

For example, the processing unit 13 may calculate the at least one transferring probability of each of the operation statuses S1, S2, S3, START and END by performing the following operations on each of the operation statuses S1, S2, S3, START and END: (a) counting a first number of times of entering into the operation status according to the temporal sequence and the first recorded statuses, (b) determining at least one transferring status that the appliance entered into after exiting the operation status according to the temporal sequence and the first recorded statuses, wherein each of the at least one transferring status is one of the operation statuses S1, S2, S3, START and END, (c) counting at least one second number of times of entering into each of the at least one transferring status from the operation status according to the temporal sequence and the first recorded statuses, and (d) dividing each of the at least one second number by the first number to obtain the at least one transferring probability of the operation status.

Now, the operation status S1 will be taken as an example for further description. The processing unit 13 counts the first number of times of entering into the operation status S1 according to the temporal sequence and the first recorded statuses. Taking the first power consumption data 10b, 10c depicted in FIG. 1B as an example, the first power consumption datum 10c follows immediately after the first power consumption datum 10b, so it means that the appliance 19 entered into the operation status S1 after exiting the operation status S2. The processing unit 13 counts the first number of times of entering into the operation status S1 just according to this kind of information. On the other hand, the processing unit 13 also determines which status the appliance 19 enters into after exiting the operation status S1 according to the temporal sequence and the first recorded statuses, and takes the status as the transferring status of the operation status S1. Taking the first power consumption data 10a, 10b as well as the first power consumption data 10c, 10d depicted in FIG. 1B as an example, the appliance 19 enters into the operation status S2 after exiting the operation status S1 in both cases. Therefore, the processing unit 13 determines that the operation status S1 has one transferring status which is the operation status S2. Then, the processing unit 13 counts at least one second number of times of entering into each of the at least one transferring status (i.e., the operation status S2) from the operation status S1 according to the temporal sequence and the first recorded statuses. Thereafter, the processing unit 13 divides each of the at least one second number by the first number to obtain the at least one transferring probability of the operation status S1.

For ease of understanding, the power consumption model established for the appliance 19 by the processing unit 13 is shown in FIG. 1C. The five circles in FIG. 1C represent the operation statuses S1, S2, S3, START and END, with each of the operation statuses S1, S2, S3, START and END having an average operation time length. Additionally, the transferring probability of entering into the operation status S1 from the operation status START is ρ₀₁, the transferring probability of entering into the operation status S2 from the operation status S1 is ρ₁₂, the transferring probabilities of entering into the operation statuses S1, S3 respectively from the operation status S2 are ρ₂₁ and ρ₂₃, and the transferring probabilities of entering into the operation statuses S1, END respectively from the operation status S3 are ρ₃₁ and ρ₃₄. It shall be appreciated that, the focus of the present invention is to establish a power consumption model for the appliance, but the power consumption model is not limited to be presented by the status transferring diagram as shown in FIG. 1C.

Through the aforesaid operations, the processing unit 13 can establish the power consumption model for the appliance 19 according to the first power consumption data 10a, 10b, 10c, 10d, . . . , 10e collected from the appliance 19. After the power consumption model of the appliance 19 is established, the subsequent power consumption of the appliance 19 can be predicted by the power consumption prediction apparatus 1. In this embodiment, the power consumption prediction apparatus 1 has an energy consumption prediction interval, which represents a time length during which the power consumption can be predicted by the processing unit 13 each time. For example, if the current time point is 10:00 AM and the energy consumption prediction interval is 15 minutes, the processing unit 13 will predict the power consumption from 10:00 AM to 10:15 AM according to the power consumption model of the appliance 19. How the power consumption prediction apparatus 1 predicts the subsequent power consumption of the appliance 19 according to the power consumption model of the appliance 19 will be described hereinbelow.

The processing unit 13 may determine a current status of the appliance 19 at a current time point and a passed dwell time length under the current status according to a power feature datum of the appliance 19. The current status is one of the operation statuses S1, S2, S3, START and END, and the passed dwell time length represents the passed time length elapsed after the appliance 19 enters into the current status this time. It shall be appreciated that, how the processing unit 13 determines which operation status (i.e., the aforesaid current status) the appliance 19 is currently in and determines the passed time length under the operation status according to the power feature datum of the appliance 19 is not the focus of the present invention, so this will not be further described herein.

Then, the processing unit 13 can predict a predicted power consumption of the appliance 19 from a current time point to a target time point recursively according to the following Equation (1):

$${E}_{H} ( {T}_{from} , {T}_{to} , t , i ) = \{ \begin{matrix}{P}_{i} + E ( {T}_{from} + 1 , {T}_{to} , t - 1 , i ) , & if t \geq 0 \\ {\sum }_{j ∈ {H}^{X}} ( E ( {T}_{from} + 1 , {T}_{to} , {s}_{j}^{h} , j ) + Δ {P}_{ij} ) \cdot {ρ}_{ij}^{h} , & if t \geq 0 \\ {P}_{i} , & if {T}_{from} = {T}_{to} \\ 0 , & if {T}_{from} > {T}_{to}\end{matrix} \qquad ( 1 )$$

In Equation (1), the variable T_{from} represents the current time point, the variable Tₜₒ represents the target time point, the variable i represents the current status, the variable t represents the remaining dwell time under the current status (i.e., the value of the variable i) of the current time point (i.e., the value of the variable T_{from}), the variable Pᵢ represents a power (i.e., an average power consumption) of the current status (i.e., the value of the variable i), the variable sⱼ^{k} represents the average operation time length of an operation status j at a time interval h, the variable ρᵢⱼ^{h} represents the probability (i.e., the aforesaid transferring probability) of entering into the operation status j from an operation status i at the time interval h, the variable H^{X} represents the set of the limited operation statuses of the appliance 19, the variable ΔPᵢⱼ represents a power change of entering into the operation status j from the operation status i, and the expected value E_{H} represents the predicted power consumption of the appliance 19 from the current time point to the target time point.

For ease of understanding, it is assumed herein that the current status is the operation status S2, the average operation time length of the operation status S2 is 30 minutes, the current time point is 10:00 AM, the energy consumption prediction interval is 15 minutes, and the passed dwell time length of the appliance 19 under the current status (i.e., the operation status S2) at the current time point (i.e., 10:00 AM) is 20 minutes. The value predicted by the processing unit 13 according to the aforesaid equation (1) is E(10:00 AM, 10:10 AM, 10, i)+Pᵢ+E(10:10 AM, 10:15 AM, 5, i).

In detail, when the processing unit 13 performs the aforesaid prediction according to Equation (1), the processing unit 13 calculates the remaining dwell time under the current status according to the energy consumption prediction interval (e.g., the aforesaid 15 minutes), the passed dwell time length (e.g., the aforesaid 20 minutes) and the average operation time length corresponding to the current status (e.g., the aforesaid 30 minutes). In the aforesaid example, the remaining dwell time of the appliance 19 under the current status at the current time point is 10 minutes, so firstly E(10:00 AM, 10:10 AM, 10, i) is calculated; then Pᵢ is added to E(10:00 AM, 10:10 AM, 10, i); and thereafter, the remaining dwell time is less than zero and a status transferring becomes necessary, so E(10:10 AM, 10:15 AM, 5, i) is further added.

Briefly speaking, as can be known from Equation (1), if the processing unit 13 determines that the remaining dwell time is not less than zero, the processing unit 13 calculates a predicted power consumption of the appliance 19 from the current time point to a target time point according to a power of the current status, the remaining dwell time, the current time point and the target time point. If the processing unit 13 determines that the remaining dwell time is less than zero, the processing unit 13 selects the at least one transferring probability of the current status as at least one selected transferring probability and calculates a predicted power consumption of the appliance 19 from the current time point to a target time point according to each of the at least one selected transferring probability, the dwell time length of the target status of each of the at least one selected transferring probability, at least one switching power of entering into the target status of each of the at least one selected transferring probability from the current status, the current time point and the target time point. If the processing unit 13 determines that the current time point is the same as the target time point, the processing unit 13 will take the power (i.e., the average power consumption) of the appliance 19 under the current status as the predicted power consumption from the current time point to the target time point. Furthermore, if the processing unit 13 determines that the current time point is later than the target time point, the predicted power consumption from the current time point to the target time point will be zero.

It shall be appreciated that, in other implementations of the present invention, the processing unit 13 may deal with the case where the remaining dwell time is less than zero in other ways. The processing unit 13 may firstly calculate at least one selected transferring probability according to the at least one transferring probability of the current status. Then, the processing unit calculates a predicted power consumption of the appliance from the current time point to a target time point according to each of the at least one selected transferring probability, the dwell time length of the target status of each of the at least one selected transferring probability, at least one switching power of entering into the target status of each of the at least one selected transferring probability from the current status, the current time point and the target time point. For example, the processing unit 13 may divide one day into several different time intervals and calculate the at least one selected transferring probability according to the different time intervals and transferring probabilities.

Thereafter, if the interface 11 further receives a plurality of second power consumption data 12a, . . . , 12b of the appliance 19, the power consumption model of the appliance 19 may be updated according to the second power consumption data 12a, . . . , 12b. Specifically, the second power consumption data 12a, . . . , 12b have a second temporal sequence. Each of the second power consumption data 12a, . . . , 12b includes a second recorded status and a second recorded time length corresponding to the second recorded status. Each of the second recorded statuses is one of the five operation statuses S1, S2, S3, START and END. The processing unit 13 updates the average operation time length of each of the operation statuses S1, S2, S3, START and END according to the second recorded statuses and the second recorded time lengths, and updates the at least one transferring probability of each of the operation statuses S1, S2, S3, START and END according to the second temporal sequence and the second power consumption data 12a, . . . , 12b in the aforesaid ways.

According to the above descriptions, the power consumption prediction apparatus 1 establishes power consumption model for the appliance 19 according to the first power consumption data 10a, 10b, 10c, 10d, . . . , 10e collected from the appliance 19. If other power consumption data are collected subsequently, the subsequently collected power consumption data will be used to update the power consumption model. Through continuous updating, the power consumption model can reliably reflect the average operation time lengths of the appliance 19 under different operation statuses and the transferring probabilities between the different operation statuses. After the power consumption model is established, the power consumption prediction apparatus 1 can accordingly predict the power consumption of the appliance 19. Briefly speaking, the power consumption prediction apparatus 1 firstly determines a current status (i.e., one of the operation statuses S1, S2, S3, START and END of the appliance 19) of the appliance 19 at a current time point and a passed dwell time length elapsed after entering into the current status this time. Thereafter, the power consumption prediction apparatus 1 calculates a remaining dwell time of the appliance 19 under the current status according to an energy consumption prediction interval, the passed dwell time length and the average operation time length corresponding to the current status. Then, the power consumption prediction apparatus 1 calculates a predicted power consumption of the appliance 19 from the current time point to a target time point according to the remaining dwell time and the information of the power consumption model.

Through the mechanism of this embodiment, the power consumption prediction apparatus 1 can establish the power consumption model of the appliance 19 and predict the future power consumption of the appliance 19 by simply using a small amount of power consumption data collected from the appliance 19 and without using any additional environment data (e.g., temperature data, humidity data and etc.).

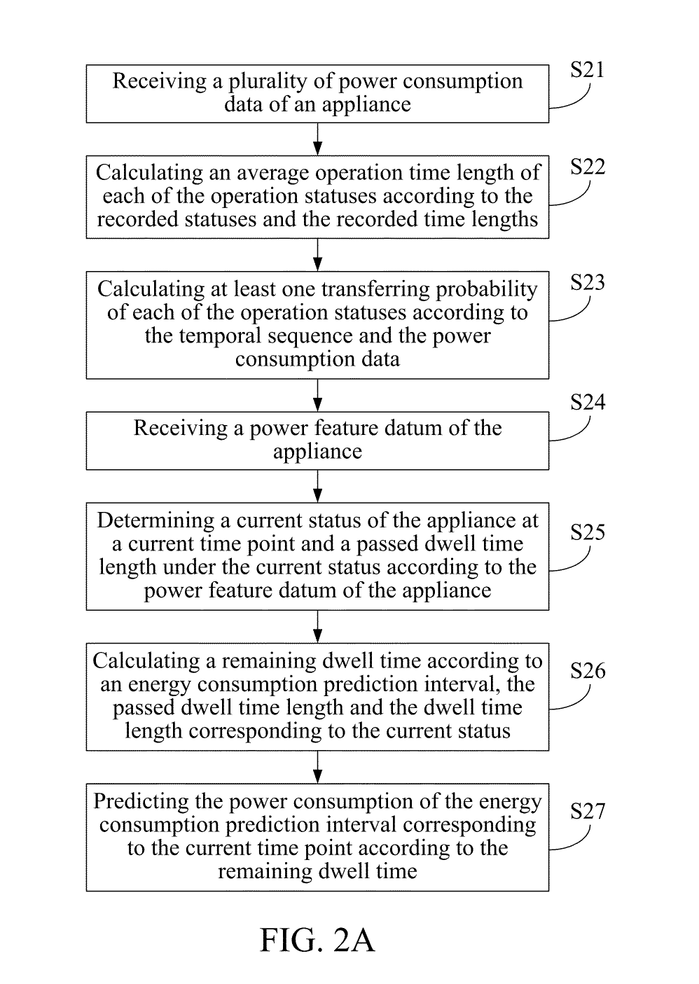

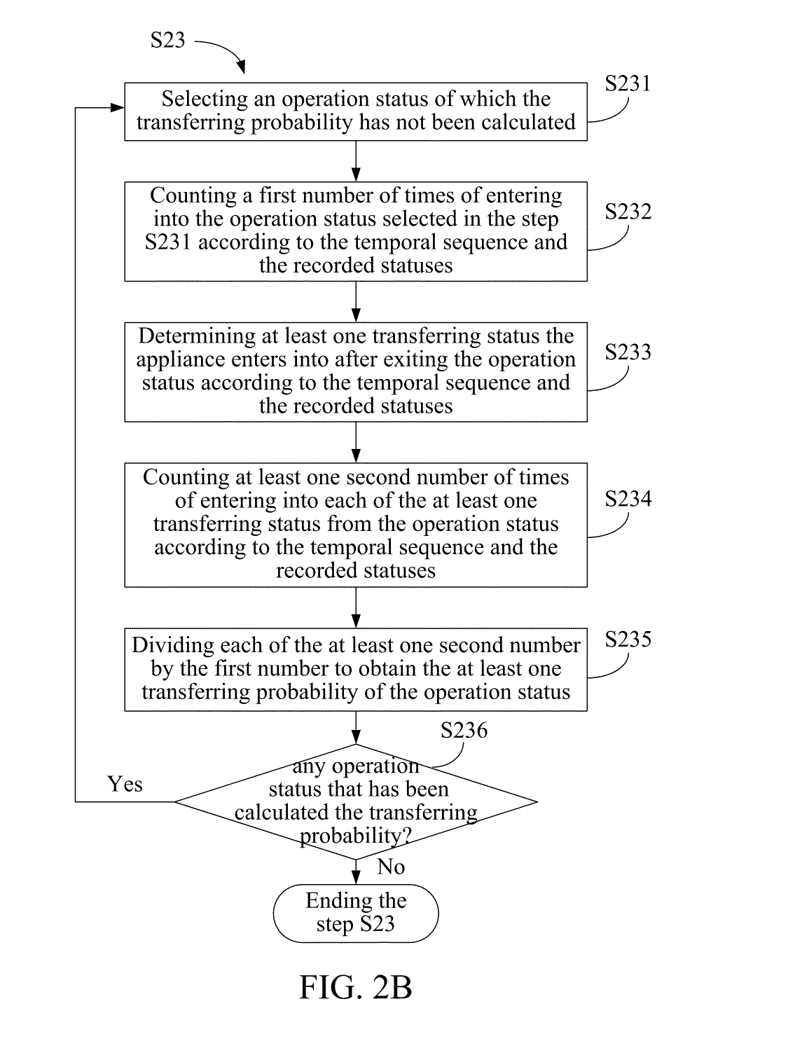

A second embodiment of the present invention is a power consumption prediction method, a main flowchart diagram of which is depicted in FIG. 2A. The power consumption prediction method of this embodiment is executed by a computer, an electronic apparatus, a processing unit or other computing devices having a computing capability.

Firstly, step S21 is executed to receive a plurality of power consumption data of an appliance. The appliance has a plurality of operation statuses, the power consumption data have a temporal sequence, each of the power consumption data includes a recorded status and a recorded time length corresponding to the recorded status, and each of the recorded statuses is one of the operation statuses.

Then, step S22 is executed to calculate an average operation time length of each of the operation statuses according to the recorded statuses and the recorded time lengths. It shall be appreciated that, in some other implementations of the present invention, the average operation time length of each of the operation statuses may be calculated by executing the following steps on each of the operation statuses in the step S22: (a) selecting at least one from the power consumption data as at least one selected power consumption datum, wherein the recorded status of each of the at least one selected power consumption datum is the operation status, and (b) averaging the at least one first recorded time length corresponding to the at least one selected power consumption datum as the average operation time length of the operation status.

Step S23 is executed to calculate at least one transferring probability of each of the operation statuses according to the temporal sequence and the power consumption data. Each of the transferring probabilities is the probability of entering into a target status from a source status, wherein the source status is one of the operation statuses, the target status is one of the operation statuses, and the source status is different from the target status.

It shall be appreciated that, in other implementations of the present invention, the transferring probabilities of all operation statuses may be calculated in the step S23 according to the process flow depicted in FIG. 2B. Firstly, step S231 is executed to select an operation status of which the transferring probability has not been calculated. Next, step S232 is executed to count a first number of times of entering into the operation status selected in the step S231 according to the temporal sequence and the recorded statuses. Step S233 is executed to determine at least one transferring status the appliance entered into after exiting the operation status according to the temporal sequence and the recorded statuses, wherein each of the at least one transferring status is one of the operation statuses. Then, step S234 is executed to count at least one second number of times of entering into each of the at least one transferring status from the operation status according to the temporal sequence and the recorded statuses. Thereafter, step S235 is executed to divide each of the at least one second number by the first number to obtain the at least one transferring probability of the operation status. Then, step S236 is executed to determine whether there is any operation status of which the transferring probability has not been calculated. If the result of the determination is “Yes” in the step S236, the step S231 to the step S235 are executed repeatedly to calculate the transferring probabilities of other operation statuses. If the result of the determination is “No” in the step S236, the step S23 is ended. End of the step S23 means that the power consumption prediction method of this embodiment has established the power consumption model for the appliance, so the power consumption of the appliance can be predicted subsequently by using the power consumption model.

Next, step S24 may be executed to receive a power feature datum of the appliance. Then, step S25 is executed to determine a current status of the appliance at a current time point and a passed dwell time length under the current status according to the power feature datum of the appliance, wherein the current status is one of the operation statuses. Thereafter, step S26 is executed to calculate a remaining dwell time according to an energy consumption prediction interval, the passed dwell time length and the average operation time length corresponding to the current status.

Then, step S27 is executed to predict the power consumption of the energy consumption prediction interval corresponding to the current time point according to the remaining dwell time. Specifically, the power consumption may be calculated recursively according to Equation (1) in the step S27. Briefly speaking, during the recursive calculation, if the remaining dwell time is not less than zero, a predicted power consumption of the appliance from the current time point to a target time point is calculated in the step S27 according to a power of the current status, the remaining dwell time, the current time point and the target time point. If the remaining dwell time is less than zero, then in the step S27, the at least one transferring probability of the current status is selected as at least one selected transferring probability and a predicted power consumption of the appliance from the current time point to a target time point is calculated according to each of the at least one selected transferring probability, the average operation time length of the target status of each of the at least one selected transferring probability, at least one switching power of entering into the target status of each of the at least one selected transferring probability from the current status, the current time point and the target time point.

On the other hand, after the step S23 is completed (i.e., after the power consumption prediction method has established the power consumption model for the appliance), other steps may be further executed by the power consumption prediction method to update the power consumption model. Specifically, a step (not shown) may be further executed by the power consumption prediction method to receive a plurality of other power consumption data of the appliance. The other power consumption data have a temporal sequence, each of the other power consumption data includes a recorded status and a recorded time length corresponding to the recorded status, and each of the recorded statuses is one of the operation statuses. Thereafter, another step is executed to update the average operation time length of each of the operation statuses according to the recorded statuses and the recorded time lengths included in the other power consumption data, and update the at least one transferring probability of each of the operation statuses according to the temporal sequence and the other power consumption data.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

Furthermore, the power consumption prediction method set forth in the second embodiment may be implemented by a computer program having a plurality of codes. The computer program is stored in a non-transitory computer readable storage medium. After the codes of the computer program are loaded into an electronic apparatus, the computer program executes the power consumption prediction method set forth in the second embodiment. The aforesaid non-transitory computer readable storage medium may be a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the present invention establishes a power consumption model of an appliance by using the power consumption data collected from the appliance. If other power consumption data are collected subsequently, the subsequently collected power consumption data will be used to update the power consumption model. Through continuous updating, the power consumption model can reliably reflect the average operation time lengths of the appliance under different operation statuses and the transferring probabilities between the different operation statuses. Once the power consumption model is established, the present invention can predict the subsequent power consumption of the appliance. Briefly speaking, the present invention firstly determines a current status (i.e., one of the operation statuses of the appliance) of the appliance at a current time point and also the passed time length elapsed after the appliance entered into the current status according to a power feature datum. Thereafter, the present invention calculates a remaining dwell time of the appliance under the current status, and then calculates a predicted power consumption of the appliance from the current time point to a target time point according to the remaining dwell time and the information of the power consumption model. Thereby, the present invention can establish the power consumption model of the appliance to predict the future power consumption of the appliance by simply using a small amount of power consumption data collected from the appliance and without using any additional environment data (e.g., temperature data, humidity data and etc.).

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A power consumption prediction apparatus, comprising:
an interface, being configured to receive a plurality of first power consumption data of an appliance, wherein the appliance has a plurality of operation statuses, the first power consumption data have a first temporal sequence, each of the first power consumption data includes a first recorded status and a first recorded time length corresponding to the first recorded status, and each of the first recorded statuses is one of the operation statuses; and
a processing unit, being electrically connected to the interface and configured to calculate an average operation time length of each of the operation statuses according to the first recorded statuses and the first recorded time lengths and calculate at least one transferring probability of each of the operation statuses according to the first temporal sequence and the first power consumption data, wherein each of the transferring probabilities is the probability of entering into a target status from a source status, the source status is one of the operation statuses, the target status is one of the operation statuses, and the source status is different from the target status.

2. The power consumption prediction apparatus as claimed in claim 1, wherein the processing unit calculates the average operation time length of each of the operation statuses by performing the following operations on each of the operation statuses:
selecting at least one from the first power consumption data as at least one selected power consumption datum, wherein the first recorded status of each of the at least one selected power consumption datum is the operation status,
averaging arithmetically the at least one first recorded time length corresponding to the at least one selected power consumption datum as the average operation time length of the operation status.

3. The power consumption prediction apparatus as claimed in claim 1, wherein the processing unit calculates the at least one transferring probability of each of the operation statuses by performing the following operations on each of the operation statuses:
counting a first number of times of entering into the operation status according to the temporal sequence and the first recorded statuses,
determining at least one transferring status that the appliance entered into after exiting the operation status according to the temporal sequence and the first recorded statuses, wherein each of the at least one transferring status is one of the operation statuses,
counting at least one second number of times of entering into each of the at least one transferring status from the operation status according to the temporal sequence and the first recorded statuses, and
dividing each of the at least one second number by the first number to obtain the at least one transferring probability of the operation status.

4. The power consumption prediction apparatus as claimed in claim 1, wherein the processing unit further determines a current status of the appliance at a current time point and a passed dwell time length under the current status according to a power feature datum of the appliance, the current status is one of the operation statuses, the processing unit further calculates a remaining dwell time according to an energy consumption prediction interval, the passed dwell time length, and the average operation time length corresponding to the current status, the processing unit further determines that the remaining dwell time is not less than zero, and the processing unit further calculates a predicted power consumption of the appliance from the current time point to a target time point according to a power of the current status, the remaining dwell time, the current time point, and the target time point.

5. The power consumption prediction apparatus as claimed in claim 1, wherein the processing unit further determines a current status of the appliance at a current time point and a passed dwell time length under the current status according to a power feature datum of the appliance, the current status is one of the operation statuses, the processing unit further calculates a remaining dwell time according to an energy consumption prediction interval, the passed dwell time length, and the average operation time length corresponding to the current status, the processing unit further determines that the remaining dwell time is less than zero, the processing unit further selects the at least one transferring probability of the current status as at least one selected transferring probability, and the processing unit further calculates a predicted power consumption of the appliance from the current time point to a target time point according to each of the at least one selected transferring probability, the average operation time length of the target status of each of the at least one selected transferring probability, at least one switching power of entering into the target status of each of the at least one selected transferring probability from the current status, the current time point, and the target time point.

6. The power consumption prediction apparatus as claimed in claim 1, wherein the processing unit further determines a current status of the appliance at a current time point and a passed dwell time length under the current status according to a power feature datum of the appliance, the current status is one of the operation statuses, the processing unit further calculates a remaining dwell time according to the passed dwell time length and the average operation time length corresponding to the current status, the processing unit further determines that the remaining dwell time is less than zero, the processing unit further calculates at least one selected transferring probability according to the at least one transferring probability of the current status, and the processing unit further calculates a predicted power consumption of the appliance from the current time point to a target time point according to each of the at least one selected transferring probability, the average operation time length of the target status of each of the at least one selected transferring probability, at least one switching power of entering into the target status of each of the at least one selected transferring probability from the current status, the current time point and the target time point.

7. The power consumption prediction apparatus as claimed in claim 1, wherein the interface further receives a plurality of second power consumption data of the appliance, the second power consumption data have a second temporal sequence, each of the second power consumption data includes a second recorded status and a second recorded time length corresponding to the second recorded status, and each of the second recorded statuses is one of the operation statuses, the processing unit further updates the average operation time length of each of the operation statuses according to the second recorded statuses and the second recorded time lengths, and updates the at least one transferring probability of each of the operation statuses according to the second temporal sequence and the second power consumption data.

8. A computer-implemented power consumption prediction method, comprising:
(a) receiving a plurality of first power consumption data of an appliance, wherein the appliance has a plurality of operation statuses, the first power consumption data have a first temporal sequence, each of the first power consumption data includes a first recorded status and a first recorded time length corresponding to the first recorded status, and each of the first recorded statuses is one of the operation statuses;
(b) calculating an average operation time length of each of the operation statuses according to the first recorded statuses and the first recorded time lengths; and
(c) calculating at least one transferring probability of each of the operation statuses according to the first temporal sequence and the first power consumption data;
wherein each of the transferring probabilities is the probability of entering into a target status from a source status, the source status is one of the operation statuses, the target status is one of the operation statuses, and the source status is different from the target status.

9. The power consumption prediction method as claimed in claim 8, wherein the average operation time length of each of the operation statuses is calculated by executing the following steps on each of the operation statuses in the step (c):
selecting at least one from the first power consumption data as at least one selected power consumption datum, wherein the first recorded status of each of the at least one selected power consumption datum is the operation status; and
averaging arithmetically the at least one first recorded time length corresponding to the at least one selected power consumption datum as the average operation time length of the operation status.

10. The power consumption prediction method as claimed in claim 8, wherein the at least one transferring probability of each of the operation statuses is calculated by executing the following steps on each of the operation statuses in the step (c):
counting a first number of times of entering into the operation status according to the temporal sequence and the first recorded statuses;
determining at least one transferring status that the appliance entered into after exiting the operation status according to the temporal sequence and the first recorded statuses, wherein each of the at least one transferring status is one of the operation statuses;
counting at least one second number of times of entering into each of the at least one transferring status from the operation status according to the temporal sequence and the first recorded statuses; and
dividing each of the at least one second number by the first number to obtain the at least one transferring probability of the operation status.

11. The power consumption prediction method as claimed in claim 8, further comprising:
determining a current status of the appliance at a current time point and a passed dwell time length under the current status according to a power feature datum of the appliance, wherein the current status is one of the operation statuses;
calculating a remaining dwell time according to an energy consumption prediction interval, the passed dwell time length and the average operation time length corresponding to the current status;
determining that the remaining dwell time is not less than zero; and
calculating a predicted power consumption of the appliance from the current time point to a target time point according to a power of the current status, the remaining dwell time, the current time point and the target time point.

12. The power consumption prediction method as claimed in claim 8, further comprising:
determining a current status of the appliance at a current time point and a passed dwell time length under the current status according to a power feature datum of the appliance, wherein the current status is one of the operation statuses;
calculating a remaining dwell time according to the passed dwell time length and the average operation time length corresponding to the current status;
determining that the remaining dwell time is less than zero;
selecting the at least one transferring probability of the current status as at least one selected transferring probability; and
calculating a predicted power consumption of the appliance from the current time point to a target time point according to each of the at least one selected transferring probability, the average operation time length of the target status of each of the at least one selected transferring probability, at least one switching power of entering into the target status of each of the at least one selected transferring probability from the current status, the current time point and the target time point.

13. The power consumption prediction method as claimed in claim 8, further comprising:
determining a current status of the appliance at a current time point and a passed dwell time length under the current status according to a power feature datum of the appliance, wherein the current status is one of the operation statuses;
calculating a remaining dwell time according to an energy consumption prediction interval, the passed dwell time length and the average operation time length corresponding to the current status;
determining that the remaining dwell time is less than zero;
calculating at least one selected transferring probability according to the at least one transferring probability of the current status; and
calculating a predicted power consumption of the appliance from the current time point to a target time point according to each of the at least one selected transferring probability, the average operation time length of the target status of each of the at least one selected transferring probability, at least one switching power of entering into the target status of each of the at least one selected transferring probability from the current status, the current time point and the target time point.

14. The power consumption prediction method as claimed in claim 8, further comprising:
receiving a plurality of second power consumption data of the appliance, the second power consumption data have a second temporal sequence, each of the second power consumption data includes a second recorded status and a second recorded time length corresponding to the second recorded status, and each of the second recorded statuses is one of the operation statuses;
updating the average operation time length of each of the operation statuses according to the second recorded statuses and the second recorded time lengths; and
updating the at least one transferring probability of each of the operation statuses according to the second temporal sequence and the second power consumption data.

15. A non-transitory computer readable storage medium having a computer program stored therein, the computer program executes a power consumption prediction method after being loaded into an electronic apparatus, and the power consumption prediction method comprising:
receiving, by the electronic apparatus, a plurality of power consumption data of an appliance, wherein the appliance has a plurality of operation statuses, the power consumption data have a temporal sequence, each of the power consumption data includes a recorded status and a recorded time length corresponding to the recorded status, and each of the recorded statuses is one of the operation statuses;
calculating, by the electronic apparatus, an average operation time length of each of the operation statuses according to the recorded statuses and the recorded time lengths; and
calculating, by the electronic apparatus, at least one transferring probability of each of the operation statuses according to the temporal sequence and the power consumption data;
wherein each of the transferring probabilities is the probability of entering into a target status from a source status, the source status is one of the operation statuses, the target status is one of the operation statuses, and the source status is different from the target status.

16. The non-transitory computer readable storage medium as claimed in claim 15, wherein the power consumption prediction method further comprises:
determining, by the electronic apparatus, a current status of the appliance at a current time point and a passed dwell time length under the current status according to a power feature datum of the appliance, wherein the current status is one of the operation statuses;
calculating, by the electronic apparatus, a remaining dwell time according to the passed dwell time length and the average operation time length corresponding to the current status;
determining, by the electronic apparatus, that the remaining dwell time is not less than zero; and
calculating, by the electronic apparatus, a predicted power consumption of the appliance from the current time point to a target time point according to a power of the current status, the remaining dwell time, the current time point and the target time point.
